(19) United States
(12) Patent Application Publication
(10) Pub. No.: US 2006/0031669 A1
(43) Pub. Date: Feb. 9, 2006

(54) Boot method and system

(75) Inventors: Ivan Liang, Taipei City (TW); Jyhming Feng, Taipei City (TW); Eddy Fu, YongHe City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/048,199

(22) Filed: Feb. 1, 2005

(30) Foreign Application Priority Data
Aug. 6, 2004 (TW) 93123602

(51) Int. Cl. G06F 1/24

(52) U.S. Cl. 713/100

(57) ABSTRACT

Boot methods and systems for use in a processor-based electronic device. A register content table is provided in the electronic device. The register content table records specific hardware of the electronic device and a corresponding initialization setting. When the electronic device boots, rather than detecting connected devices, initialization of specific hardware is directly performed according to the initialization setting in the register content table.

### BACKGROUND

The invention relates to boot management, and particularly to methods and systems that boot an electronic device, such as a computer system.

Processor-based devices, such as computer systems, are widely used by enterprises and individuals. In a conventional boot procedure for a computer system, POST (Power On Self Test) operations are first performed after the computer system is powered on. Then, BIOS (Basic Input/Output System) is loaded to confirm the basic hardware architecture, comprising clock and hard disk information of the computer system, and to perform necessary initializations thereto. Afterward, a boot loader in MBR (Master Boot Record) loads an OS (Operating System) kernel.

After the OS kernel is loaded, control of the computer system is transferred to the OS kernel. The OS kernel continues to load a file system, and detect connected devices. Once any device is detected, the type of the device is identified, and a procedure for initiating the device is performed, thereby completing the boot procedure of the computer system.

As described above, a boot procedure comprises several programs to handle complex detection and determination. Respective programs require file space based on capability, and can be stored in non-successive locations of the disk. Therefore, it takes time to load the programs, prolonging the boot procedure. Additionally, since detection, determination, and initialization of devices must be performed during the boot procedure, also time-consuming. The process is inefficient for some computer systems, such as embedded systems providing specific capabilities or services.

### SUMMARY

Boot methods are provided. In an exemplary embodiment of a boot method, a register content table is first provided in an electronic device. The register content table records at least specific hardware of the electronic device and a corresponding initialization setting. When the electronic device boots, rather than detecting connected devices, initialization of the specific hardware is directly performed according to the initialization setting in the register content table.

An OS is further loaded on the electronic device, thereby executing the OS on the electronic device.

A boot device with OS kernel files therein are further detected, and loaded on the electronic device.

Initialization of at least shared hardware is further performed by a loader in the BIOS of the electronic device.

Boot systems are further provided. An exemplary system comprises a register content table and a loader. The register content table records at least specific hardware of the electronic device and a corresponding initialization setting. When an electronic device boots, rather than detecting connected devices, the loader directly initiates the specific hardware according to the initialization setting in the register content table.

The loader further loads an OS for execution on the electronic device.

The loader further detects a boot device with OS kernel files therein, and loads the files on the electronic device.

The loader further initiates at least shared hardware by the BIOS of the electronic device.

The above-mentioned embodiments of methods and systems may take the form of program code embodied in a tangible media. When the program code is loaded into and executed by a machine, the machine can become an apparatus for practicing the disclosed methods.

### DESCRIPTION OF THE DRAWINGS

Boot methods and systems according to embodiments of the invention will become more fully understood by referring to the following detailed description with reference to the accompanying drawings, wherein:

FIG. 1 is a schematic diagram illustrating the architecture of an embodiment of a boot system;

FIG. 2 shows an example of a register content table;

FIG. 3 is a flowchart showing an embodiment of a boot method; and

FIG. 4 is a schematic diagram illustrating a storage medium storing a computer program for execution of an embodiment of a boot method.

### DESCRIPTION

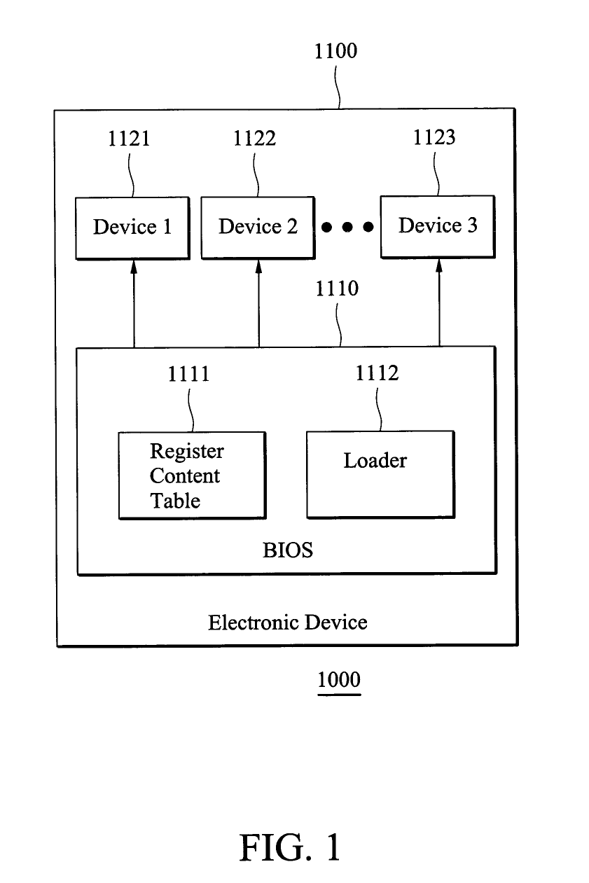

FIG. 1 is a schematic diagram illustrating the architecture of an embodiment of a boot system.

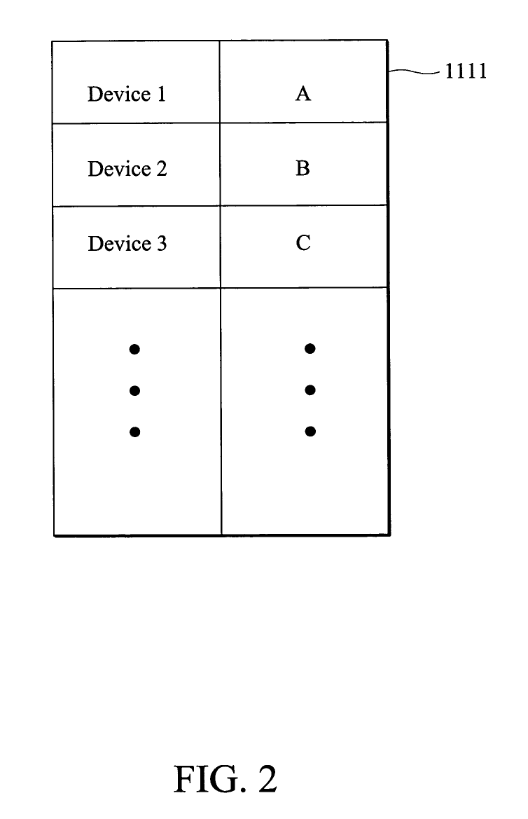

Boot system 1000 is suitable for use in a processor-based electronic device 1100, such as a computer system or an embedded system. The electronic device 1100 comprises at least a BIOS 1110, and hardware devices, such as device 1 (1121), device 2 (1122), and device 3 (1123). The BIOS 1110 comprises a register content table 1111 and a loader 1112. The register content table 1111 records specific hardware of the electronic device 1100 and corresponding initialization settings. FIG. 2 shows an example of a register content table. In FIG. 2, the settings for device 1 (1121), device 2 (1122), and device 3 (1123) are “A”, “B”, and “C”, respectively. It is understood that “A”, “B”, and “C” are only schematic representations, and can be changed according to the type of hardware. Additionally, the list order for device 1 (1121), device 2 (1122), and device 3 (1123) in the register content table 1111 can be determined based on the initialization order when the electronic device 1100 boots. The loader 1112 can be programmed in the read only memory in advance for execution of the boot mechanism. Details follow.

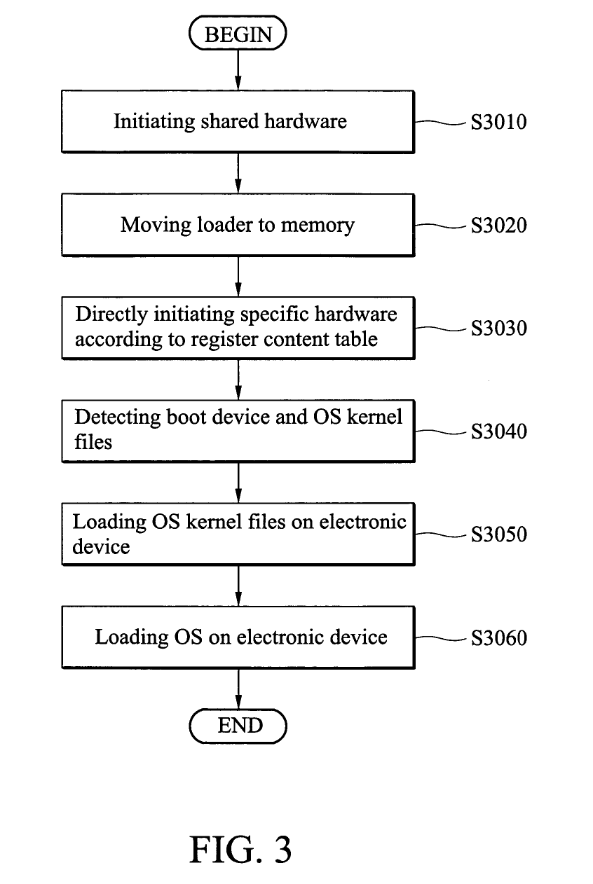

FIG. 3 is a flowchart showing an embodiment of a boot method.

After the electronic device 1100 is powered on, in step S3010, the loader 1112 first initiates necessary shared hardware of the electronic device 1100, such as memory. After the memory is initiated, in step S3020, the loader 1112 is moved to the memory. Then, in step S3030, rather than detecting connected devices of the electronic device 1100, the loader 1112 directly initiates the specific hardware, such as device 1 (1121), device 2 (1122), and device 3 (1123) according to the initialization setting in the register content table 1111. The specific hardware may comprise a Northbridge chip, a Southbridge chip, a display card, connection ports, and other components of the electronic device 1100. Northbridge and Southbridge chips can be first initiated. The serial port is then initiated, such that debug and error messages can be output via the serial port. Finally, the display card/TV is initiated to display messages.

Thereafter, in step S3040, the loader 1112 detects a boot device (not shown in FIG. 1) with OS kernel files therein, and in step S3050, loads the files on the electronic device 1100. Then, in step S3060, the loader 1112 loads an OS on the electronic device 1100, thereby executing the OS on the electronic device 1100, and completing the boot procedure of the electronic device 1100. Specific hardware of computer systems is efficiently initiated, completing the boot procedure.

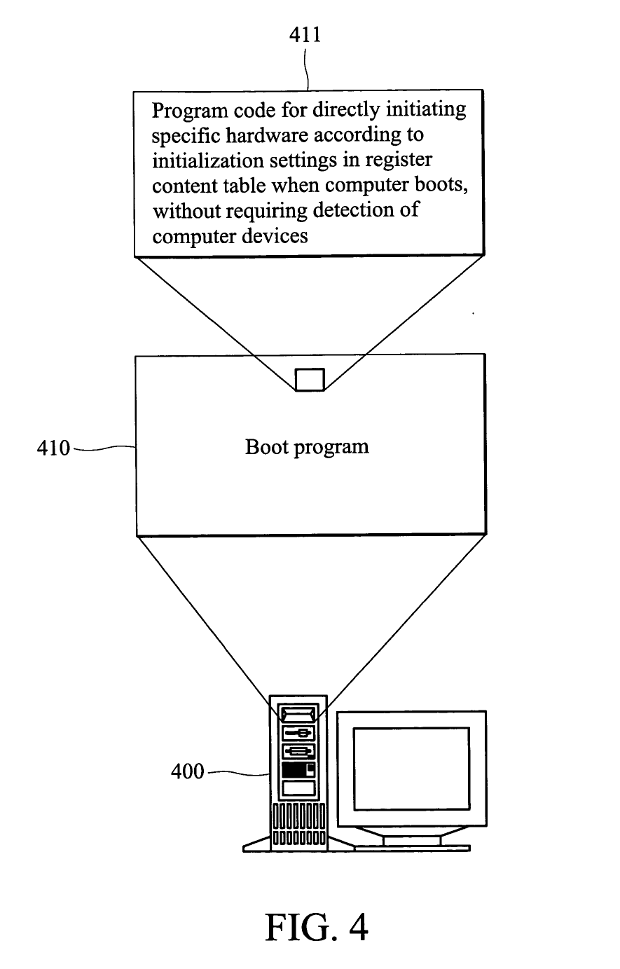

FIG. 4 is a diagram of a storage medium storing a computer program providing an embodiment of a fast boot method. The computer program product comprises a storage medium 410 having computer readable program code embodied therein for use in a computer system 400. The computer readable program code comprises at least computer readable program code 411 directly initiating specific hardware according to initialization settings in a register content table when the computer boots, without requiring detection of devices of the computer.

Boot systems and methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the embodiments. The method and system may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed embodiments. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A boot method for use in a processor-based electronic device, comprising:
providing a register content table in the electronic device, recording at least specific hardware of the electronic device and a corresponding initialization setting; and
directly initiating the specific hardware according to the initialization setting in the register content table when the electronic device boots, without requiring detection of devices connected with at least one connection port of the electronic device.

2. The method of claim 1 further comprising loading an OS (Operating System) on the electronic device, and executing the OS on the electronic device.

3. The method of claim 2 further comprising detecting a boot device and OS kernel files therein, and loading the files on the electronic device.

4. The method of claim 1 further comprising initialing at least shared hardware.

5. The method of claim 4 wherein the shared hardware comprises memory of the electronic device.

6. The method of claim 5 further comprising performance of the initialization procedure of the shared hardware by a loader in the BIOS of the electronic device.

7. The method of claim 6 further comprising moving the loader to the memory after the memory is initiated.

8. The method of claim 1 wherein the specific hardware comprises a Northbridge chip, a Southbridge chip, a display card, or connection ports.

9. A boot system for use in a processor-based electronic device, comprising:
a register content table recording at least specific hardware of the electronic device and a corresponding initialization setting; and
a loader directly initiating the specific hardware according to the initialization setting in the register content table when the electronic device boots, without requiring detection of devices connected with at least one connection port of the electronic device.

10. The system of claim 9 wherein the loader further loads an OS (Operating System) on the electronic device, and executes the OS on the electronic device.

11. The system of claim 10 wherein the loader further detects a boot device with OS kernel files therein, and loads the files on the electronic device.

12. The system of claim 9 wherein the loader further initiates at least shared hardware.

13. The system of claim 12 wherein the shared hardware comprises memory of the electronic device.

14. The system of claim 13 wherein the loader is integrated in the BIOS of the electronic device.

15. The system of claim 14 wherein the loader is further moved to the memory after the memory is initiated.

16. The system of claim 9 wherein the specific hardware comprises a Northbridge chip, a Southbridge chip, a display card, or connection ports.

17. A machine-readable storage medium storing a computer program, causing, when executed, a computer to perform a boot method, the method comprising:
directly initiating specific hardware according to initialization settings in a register content table when the computer boots, without requiring detection of devices of the computer,
wherein the register content table records at least specific hardware of the electronic device and a corresponding initialization setting.

18. The storage medium of claim 17, wherein the method further comprising loading an OS (Operating System) on the electronic device, and executing the OS on the electronic device.

19. The storage medium of claim 18, wherein the method further comprising detecting a boot device with OS kernel files therein, and loading the files on the electronic device.

20. The storage medium of claim 17, wherein the method further comprising performance of the initialization procedure by the BIOS of the electronic device.
